(19) United States
(12) Patent Application Publication
(10) Pub. No.: US 2013/0057974 A1
(43) Pub. Date: Mar. 7, 2013

(54) LENS MODULE SOCKET

(71) Applicants: HONG-TU ZHANG, Dong-Guan (CN); Ai-Gong Chi, Dong-Guan (CN); Ping-Chih Chen, New Taipei City (TW); Ming-Chiang Chen, New Taipei City (TW)

(72) Inventors: HONG-TU ZHANG, Dong-Guan (CN); Ai-Gong Chi, Dong-Guan (CN); Ping-Chih Chen, New Taipei City (TW); Ming-Chiang Chen, New Taipei City (TW)

(73) Assignee: Cheng Uei Precision Industry Co., LTD., New Taipei City (TW)

(21) Appl. No.: 13/227,434

(22) Filed: Sep. 7, 2011

(51) Int. Cl. G02B 7/02

(52) U.S. Cl. 359/819

(57) ABSTRACT

A lens module socket includes an insulating housing, a plurality of conductive terminals, an inner shielding shell and an outer shielding shell. The insulating housing has an accommodating space therein for receiving the lens module and a plurality of buckling grooves distributed at outsides of corresponding side walls thereof. The conductive terminals are assembled in the insulating housing. The inner shielding shell surrounds the insulating housing, and has a plurality of side plates which define a plurality of through-holes corresponding to the respective buckling grooves. The outer shielding shell covered on the insulating housing includes a top plate and a plurality of lateral plates extending downward from a periphery of the top plate and defining a plurality of openings. A buckling arm is extended upward and bent inward from a bottom of each opening to be buckled in the corresponding buckling groove through the through-hole.

### BACKGROUND OF THE INVENTION

1. Field of the Invention

The present invention generally relates to a lens module socket, and more particularly to a lens module socket capable of receiving a lens module therein firmly.

2. The Related Art

With fast development of electronic technology, function of an electronic product is requested higher and higher. In order to satisfy different needs of consumers and simultaneously improve purchasing wish of the consumers, most of the current electronic products are designed to be multifunctional, such as a camera shooting function. So, a lens module socket needs to be connected between a lens module and a printed circuit board of the electronic product to realize the camera shooting function.

A conventional lens module socket connected between the lens module and the printed circuit board of the electronic product includes an insulating housing and a shielding shell encircling the insulating housing. The shielding shell has a fastening portion. The lens module has a fastening groove matched with the fastening portion. The lens module is received in the insulating housing and the shielding shell is mounted around the insulating housing with the fastening portion of the shielding shell received in the fastening groove of the lens module to fasten the lens module in the insulating housing of the lens module socket.

However, the fastening portion of the shielding shell is received in the fastening groove of the lens module directly that makes the shielding shell to be apt to contact with a conductive portion of the lens module to generate a short circuit between the lens module and the shielding shell. Furthermore, an interval between an outer periphery of the lens module and an inner periphery of the insulating housing is usually narrow that makes the shielding shell inconveniently fastened to the lens module. As a result, application performance of the lens module is lowered.

### SUMMARY OF THE INVENTION

An object of the present invention is to provide a lens module socket adapted for connecting a lens module with a printed circuit board of a product includes an insulating housing, a plurality of conductive terminals, an inner shielding shell and an outer shielding shell. The insulating housing has a bottom wall and a plurality of side walls protruded upward from a periphery of the bottom wall to surround an accommodating space thereamong for receiving the lens module. A plurality of buckling grooves are distributed at outsides of the corresponding side walls. The conductive terminals are assembled in the insulating housing to be electrically connected between the lens module and the printed circuit board. The inner shielding shell surrounds the insulating housing, and has a plurality of side plates. The through-holes are defined in the corresponding side plates. The side plates are attached to the outsides of the respective side walls with the through-holes corresponding to the respective buckling grooves. The outer shielding shell is covered on the insulating housing. The outer shielding shell has a top plate and a plurality of lateral plates extending downward from a periphery of the top plate. The top plate defines an insertion hole. A top of the lens module is exposed from the insertion hole. The openings are defined in the corresponding lateral plates. A buckling arm is extended upward and bent inward from a bottom of each opening. Each lateral plate is attached to an outside of the corresponding side plate with an upper portion of the buckling arm buckled in the corresponding buckling groove through the through-hole.

As described above, the upper portions of the buckling arms are buckled in the buckling grooves via the through-holes to integrate the insulating housing with the inner shielding shell and the outer shielding shell tightly and conveniently so as to make the lens module fastened in the accommodating space firmly. The above-mentioned fastening method can avoid the outer shielding shell contacting with a conductive portion of the lens module directly to cause a short circuit. As a result, application performance of the lens module is improved.

### BRIEF DESCRIPTION OF THE DRAWINGS

The present invention will be apparent to those skilled in the art by reading the following description, with reference to the attached drawings, in which:

FIG. 1 is a perspective view of a lens module socket in accordance with the present invention, wherein a lens module is assembled in the lens module socket;

FIG. 2 is an exploded view of the lens module socket of FIG. 1, wherein the lens module is taken out of the lens module socket;

FIG. 3 is another angle exploded view of the lens module socket of FIG. 1, wherein the lens module is taken out of the lens module socket;

FIG. 4 is a front view of the assembly of the lens module socket and the lens module of FIG. 1;

FIG. 5 is a sectional view of the assembly of the lens module socket and the lens module of FIG. 4; and

FIG. 6 is an enlarged assembly perspective view of section “B” of the lens module socket and the lens module shown in FIG. 5.

### DETAILED DESCRIPTION OF THE PREFERRED EMBODIMENT

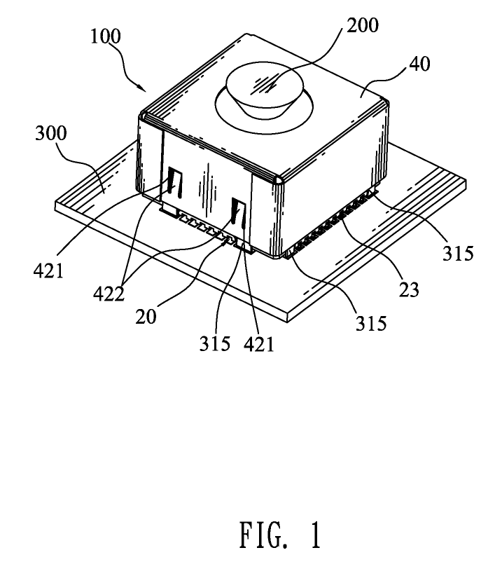

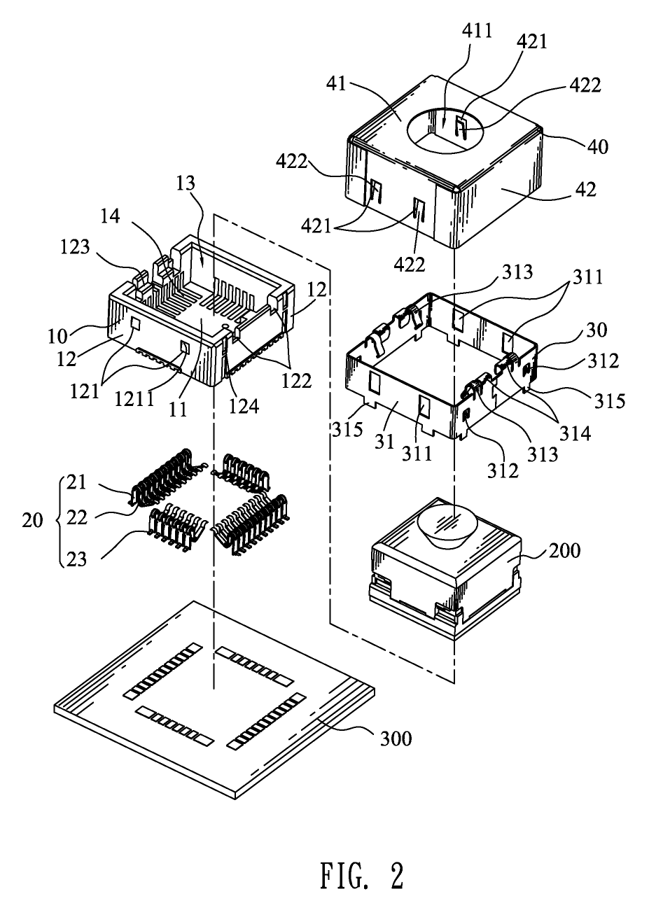

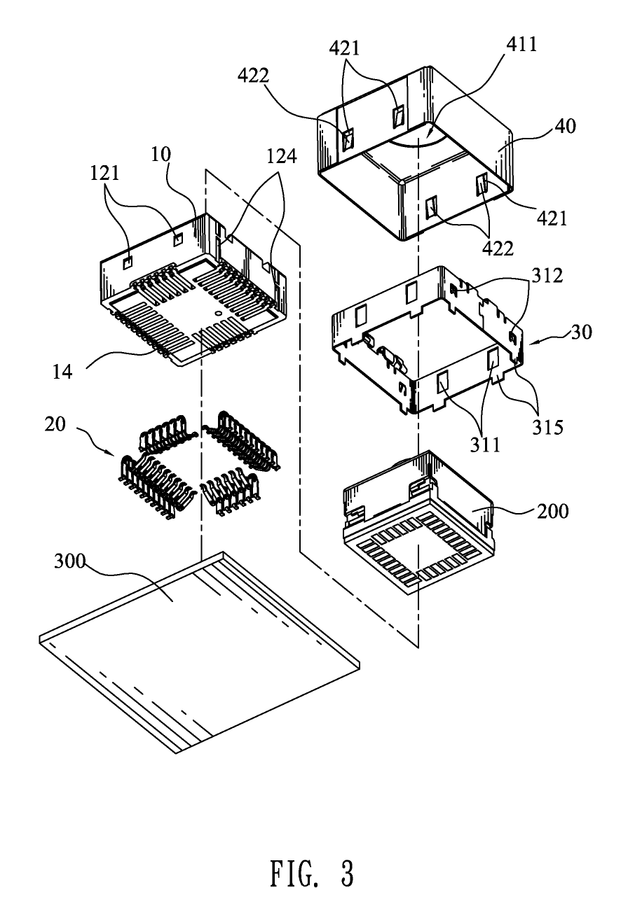

With reference to FIG. 1, FIG. 2 and FIG. 3, a lens module socket 100 in accordance with the present invention is shown. The lens module socket 100 used for connecting a lens module 200 with a printed circuit board 300 of a product (not shown) generally includes an insulating housing 10, a plurality of conductive terminals 20, an inner shielding shell 30 and an outer shielding shell 40.

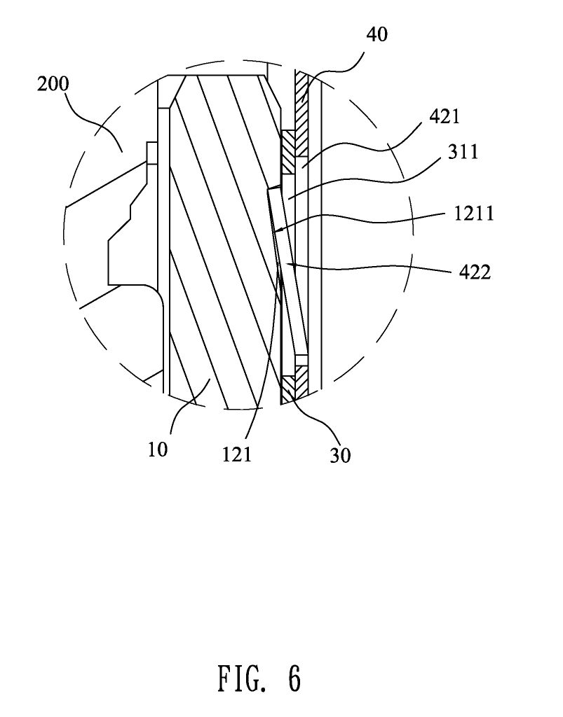

Referring to FIG. 2, FIG. 3 and FIG. 6, the insulating housing 10 has a square bottom wall 11 disposed levelly and four side walls 12 protruded upward from four sides of the bottom wall 11 to surround an accommodating space 13 thereamong. A junction of the bottom wall 11 and each side wall 12 defines a plurality of L-shaped terminal grooves 14. Outsides of two opposite side walls 12 are respectively concaved inward to define two spaced buckling grooves 121 each of which has an inclined inner surface 1211 inclined outward from a top to a bottom thereof. The other two opposite side walls 12 respectively define two notches 124, two first fastening grooves 122 located between the two notches 124, and two second fastening grooves 123 located between the two first fastening grooves 122 and spaced from each other. Each of the notches 124 is concaved inward from a top of an outer surface of the side wall 12. Each of the first fastening grooves 122 is concaved outward from two sides of an inner surface of the corresponding side wall 12 with a top thereof penetrating through a top end of the side wall 12. Each of the second fastening grooves 123 is concaved outward from a top of the inner surface of the side wall 12.

Referring to FIG. 2, each of the conductive terminals 20 has a base portion 21 disposed vertically, a contact portion 22 arced downward and then bent upward from a top end of the base portion 21, and a soldering portion 23 extending horizontally and opposite to the contact portion 22 from a bottom end of the base portion 21.

Referring to FIG. 2 and FIG. 3, the inner shielding shell 30 is looped from a metal plate, and has two opposite first side plates 31 and two opposite second side plates 32. Two sides of each first side plate 31 define two rectangular through-holes 311 spaced from each other. Two sides of each second side plate 31 are punched inward to define two elastic arms 312. Two first fastening portions 313 are extended upward and then bent inward from a top of each second side plate 32. Two second fastening portions 314 are protruded upward and then bent inward from the top of each second side plate 31 and located between the two first fastening portions 313. The inner shielding shell 30 defines a plurality of soldering arms 315 extending downward from a bottom of a periphery of the inner shielding shell 30.

Referring to FIG. 2 and FIG. 3, the outer shielding shell 40 has a square top plate 41 and a plurality of lateral plates 42 extending downward from a periphery of the top plate 41. A top of the top plate 41 defines an insertion hole 411. Two of the lateral plates 42 opposite to each other respectively define two openings 421. A bottom inner side of each opening 421 extends upward and then inclined inward to form a buckling arm 422 substantially matching with the inclined inner surface 1211 when the outer shielding shell 40 is mounted to the inner shielding shell 30.

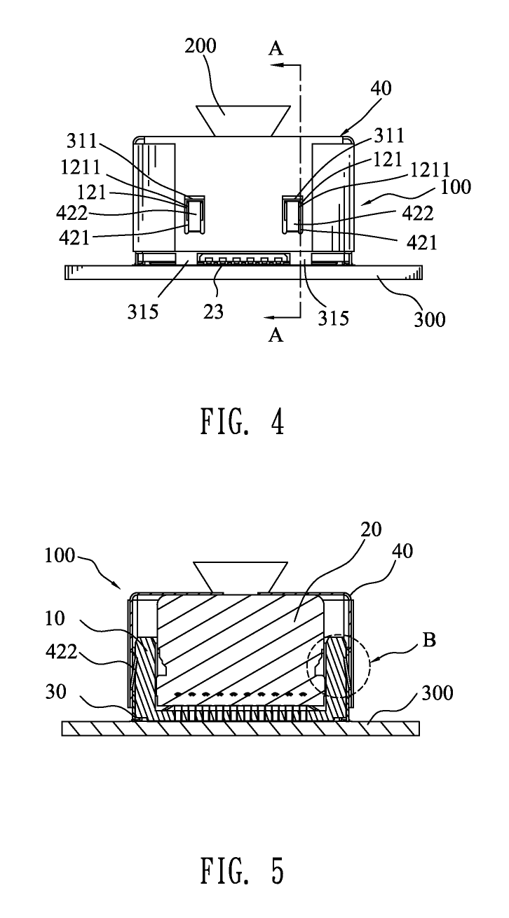

Referring to FIGS. 1-6, in assembly, the base portion 21 and the contact portion 22 of the conductive terminals 20 are received in the terminal grooves 14 with the contact portion 22 projected into the accommodating space 13. The inner shielding shell 30 surrounds the insulating housing 10 with the elastic arms 312 buckled in the notches 124, the first and second fastening portions 313, 314 fastened in the first and second fastening grooves 122, 123 to integrate the inner shielding shell 30 with the insulating housing 10 tightly. The buckling grooves 121 are corresponding to the respective through-holes 311. A bottom of the through-hole 311 is lower than a bottom of the buckling groove 121 for allowing a lower portion of the buckling arm 422 passing therethrough. A top of the through-hole 311 is higher than a top of the buckling groove 121 in order to facilitate the buckling arm 422 buckled in the corresponding buckling groove 121.

Then, the lens module 200 is assembled into the accommodating space 13 of the insulating housing 10 with the first fastening portions 313 resisting against two side surfaces of the lens module 200 to limit the lens module 200 located in the accommodating space 13 so as to prevent the lens module 200 being deviated in the accommodating space 13 of the insulating housing 10. The outer shielding shell 40 is covered on the insulating housing 10 with the inner shielding shell 30 surrounded thereon. The lateral plates 42 are attached to outsides of the corresponding first side plates 31 and the second side plates 32 with upper portions of the buckling arms 422 buckled in the buckling grooves 121 via the through-holes 311 and abutting against the inclined inner surfaces 1211 of the buckling grooves 121 to integrate the insulating housing 10 with the inner shielding shell 30 and the outer shielding shell 40 tightly so as to make the lens module 200 fastened in the accommodating space 13 firmly. At last, the soldering portion 23 of the conductive terminals 20 are stretched out of the terminal grooves 14 to be soldered on the printed circuit board 300, and the soldering arms 315 of the inner shielding shell 30 project under the insulating housing 10 to be soldered on the printed circuit board 300 to realize an electrical connection of the lens module 200 and the printed circuit board 300 of the product.

As described above, the upper portions of the buckling arms 422 are buckled in the buckling grooves 121 via the through-holes 311 to integrate the insulating housing 10 with the inner shielding shell 30 and the outer shielding shell 40 tightly and conveniently so as to make the lens module 200 fastened in the accommodating space 13 firmly. The above-mentioned fastening method can avoid the outer shielding shell 40 contacting with a conductive portion of the lens module 200 directly to cause a short circuit. As a result, application performance of the lens module 200 is improved.

What is claimed is:

1. A lens module socket adapted for connecting a lens module with a printed circuit board of a product, comprising:
an insulating housing having a bottom wall and a plurality of side walls protruded upward from a periphery of the bottom wall to surround an accommodating space thereamong for receiving the lens module, a plurality of buckling grooves being distributed at outsides of the corresponding side walls;
a plurality of conductive terminals assembled in the insulating housing to be electrically connected between the lens module and the printed circuit board;
an inner shielding shell surrounding the insulating housing, the inner shielding shell having a plurality of side plates, a plurality of through-holes being defined in the corresponding side plates, the side plates being attached to the outsides of the respective side walls with the through-holes corresponding to the respective buckling grooves; and
an outer shielding shell covered on the insulating housing, the outer shielding shell having a top plate and a plurality of lateral plates extending downward from a periphery of the top plate, the top plate defining an insertion hole, a top of the lens module exposed from the insertion hole, a plurality of openings being defined in the corresponding lateral plates, a buckling arm being extended upward and bent inward from a bottom of each opening, each lateral plate attached to an outside of the corresponding side plate with an upper portion of the buckling arm buckled in the corresponding buckling groove through the through-hole.

2. The lens module socket as claimed in claim 1, wherein the buckling arm is inclined inward from a bottom to a top thereof.

3. The lens module socket as claimed in claim 2, wherein the buckling groove has a substantially inclined inner surface which is inclined outward from a top to a bottom thereof and substantially matches with the buckling arm.

4. The lens module socket as claimed in claim 3, wherein a bottom of the through-hole is lower than a bottom of the buckling groove for allowing a lower portion of the buckling arm passing therethrough.

5. The lens module socket as claimed in claim 3, wherein a top of the through-hole is higher than a top of the buckling groove in order to facilitate the buckling arm buckled in the corresponding buckling groove.

6. The lens module socket as claimed in claim 1, wherein two sides of two opposite side walls are respectively concaved inward to define two buckling grooves, two sides of two opposite side plates respectively define two through-holes, two sides of two opposite lateral plates respectively define two openings, two buckling arms extended from the openings are buckled in the corresponding buckling grooves via the through-holes.
